(19) United States
(12) Patent Application Publication
(10) Pub. No.: US 2012/0170149 A1
(43) Pub. Date: Jul. 5, 2012

(54) SPINDLE MOTOR

(75) Inventors: Young Sun Yoo, Gyunggi-do (KR); Kyung Su Park, Gyunggi-do (KR); Ho Jun Yoo, Gyunggi-do (KR)

(73) Assignee: SAMSUNG ELECTRO-MECHANICS CO., LTD., Gyunggi-do (KR)

(21) Appl. No.: 13/033,392

(22) Filed: Feb. 23, 2011

(30) Foreign Application Priority Data
Dec. 29, 2010 (KR) 1020100137807

(51) Int. Cl. G11B 19/20

(52) U.S. Cl. 360/99.08; G9B/19.027

(57) ABSTRACT

Disclosed herein is a spindle motor, including: a rotating part having a rotating shaft and a magnet and a fixing part including a bearing supporting the rotating shaft and an armature corresponding to the magnet, the rotating part rotated by electromagnetic force of the magnet and the armature, wherein the fixing part includes: a plate supporting the rotating shaft; and a flexible circuit board mounted on the top portion of the plate and disposed between the plate and the armature to shield conduction therebetween.

### CROSS REFERENCE TO RELATED APPLICATION

This application claims the benefit of Korean Patent Application No. 10-2010-0137807, filed on Dec. 29, 2010, entitled “SPINDLE MOTOR” which is hereby incorporated by reference in its entirety into this application.

### BACKGROUND OF THE INVENTION

1. Technical Field

The present invention relates to a spindle motor.

2. Description of the Related Art

Generally, a spindle motor may maintain high-precision rotation characteristics by allowing a bearing having a rotating shaft received therein to rotatably support the rotating shaft, such that it has been widely employed as a hard disk drive, an optical disk drive, and a drive for other recording media requiring high-speed rotation.

In the spindle motor, a fluid dynamic bearing, which injects a predetermined amount of fluid between the rotating shaft facilitating the rotation of the rotating shaft and the bearing supporting the rotating shaft and generates dynamic pressure during the rotation of the rotating shaft, has been generally used.

In particular, since 2000, a shafting system of the spindle motor is rapidly changed as using a dynamic bearing, instead of using a ball bearing. The dynamic bearing has advantages of lower noise, impact resistance, and a long lifespan, as compared with the existing ball bearing type.

However, the spindle motor according to the prior art has a problem in that it is conduct with iron-based components such as a coil, a press holder, a plate, or the like, too well when the spindle motor rotates at high speed. These problems basically degrade quality. Therefore, a study of researchers has been actively conducted in order to solve these problems.

### SUMMARY OF THE INVENTION

The present invention has been made in an effort to provide a spindle motor capable of saving costs while securing high performance of a motor without adding separate components at the time of high-speed rotation.

According to a preferred embodiment of the present invention, there is provided a spindle motor including a rotating part having a rotating shaft and a magnet and a fixing part including a bearing supporting the rotating shaft and an armature corresponding to the magnet, the rotating part rotated by electromagnetic force of the magnet and the armature, wherein the fixing part includes: a plate supporting the rotating shaft; and a flexible circuit board mounted on the top portion of the plate and disposed between the plate and the armature to shield conduction therebetween.

The side end of the rotating shaft of the flexible circuit board may correspond to the shape of the top portion of the plate.

The fixing part may include a bearing holder, the plate may be provided with the fixing part of the bearing holder, and the flexible circuit board may be provided with a bending part corresponding to the fixing part.

The plate may be formed to be bent upward of the fixing part of the bearing holder and the flexible circuit board may be mounted on the top portion of the plate.

### BRIEF DESCRIPTION OF THE DRAWINGS

FIG. 1 is a diagram showing an overall spindle motor according to a first preferred embodiment of the present invention;

FIG. 2 is partially enlarged view of a spindle motor according to the first preferred embodiment of the present invention;

FIG. 3 is a cross-sectional view of a spindle motor according to a second preferred embodiment of the present invention; and

FIG. 4 is a cross-sectional view of a spindle motor according to a third preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

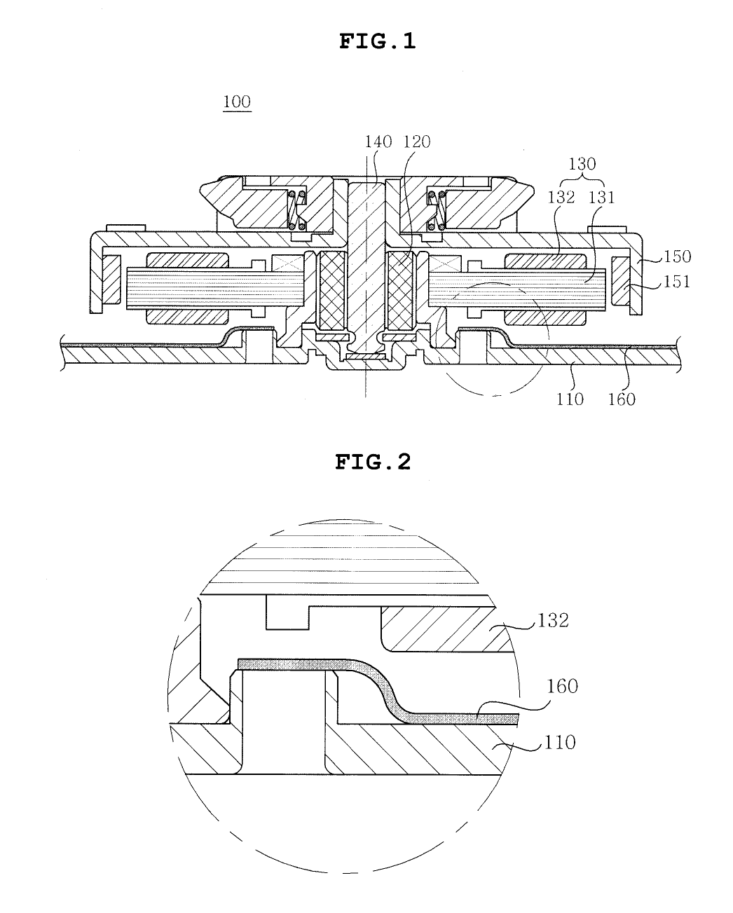

FIG. 1 is a cross-sectional view of a spindle motor according to a preferred embodiment of the present invention.

As shown in FIG. 1, a spindle motor 100 according to a preferred embodiment of the present invention may be configured to include a plate 110, a bearing 120, an armature 130, a rotating shaft 140, and a hub 150.

The plate 110, which is to fixedly support the overall spindle motor 100, is fixedly mounted on an apparatus such as a hard disk drive, or the like, in which the spindle motor 100 is mounted. In this case, the plate 110 may be made of a light material such as an aluminum plate or an aluminum alloy plate, but may be made of a steel plate.

The bearing 120, which is to rotatably support the rotating shaft 140, generally has a hollow cylindrical shape and an inner diameter portion (not shown) thereof opposite to the rotating shaft 140 is provided with fluid dynamic bearing.

The armature 130 is applied with external power in order to rotate a hub 150 on which an optical disk is mounted in order to form an electric field and is configured to include a core 131 stacking a plurality of thin metal plates and a coil 132 wound around the core 131 several times.

The core 131 is fixedly mounted on an outer peripheral surface of an inner coupling part of the plate 110 and the coil 132 is wound around the core 131. In this configuration, the coil 132 produces the electric field by current applied from the outside, thereby rotating the hub 150 by an electromagnetic force formed between the coil 132 and a magnet 151 of the hub 150.

The rotating shaft 140 is to support the hub 150 and is inserted into the inner-diameter portion of the bearing 120 and is rotatably supported by the bearing 120.

The hub 150 is to rotate an optical disk (not shown) mounted thereon, such as a hard disk, or the like, and includes a disk part (not shown) on which the rotating shaft 140 is fixedly mounted and an annular edge portion (not shown) extending from a distal end of the disk part.

The flexible circuit board 160, which is a flexible board on which electrical circuits and various electrical elements are mounted, is mounted on the top portion of the plate 110 to transmit and receive electrical signals.

The flexible circuit board 160 is partially disposed between the coil 132 and the plate 110 while being mounted on the top portion of the plate 110 in order to prevent the coil 132 of the armature 130 from being conducted with the iron-based plate 110.

The shape where the flexible circuit board 160 is disposed between the coil 132 and the plate 110 in order to prevent the coil 132 from being conducted with the plate 110 when the motor is rotated will be described in more detail with reference to FIGS. 2 to 4.

FIG. 2 is partially enlarged view of the spindle motor 100 according to the first preferred embodiment of the present invention. The flexible circuit board 160 is disposed between the plate 110 and the coil 132 while being mounted on the top portion of the plate 110 to prevent the coil 132 from being contacted and conducted with the plate 110 even at the time of rotation.

The flexible circuit board 160 is formed corresponding to the shape of the plate 110. If a step is formed on the plate 110, the flexible circuit board 160 is formed to be bent corresponding to the step shape. That is, the side end of the rotating shaft of the flexible circuit board 160 corresponds to the shape of the top portion of the plate 110.

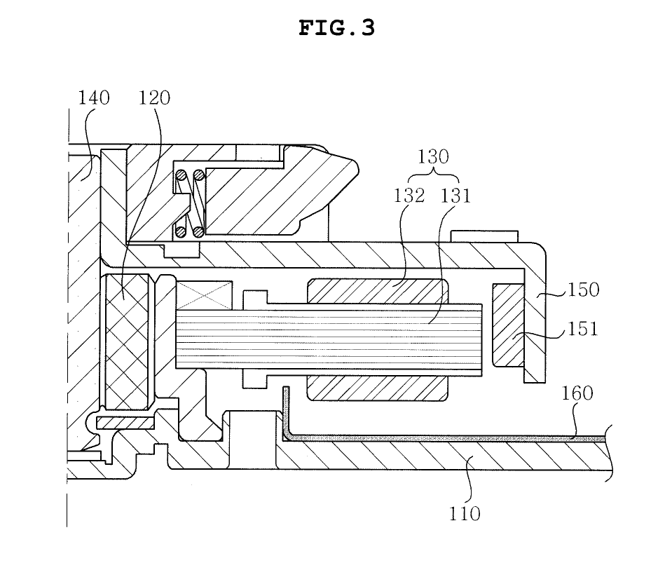

FIG. 3 is a partially enlarged view of the spindle motor 100 according to the second preferred embodiment of the present invention. The flexible circuit board 160 has an edge formed to protrude to the top portion of the plate while being mounted on the top portion of the plate 110 to prevent the coil 132 from being contacted and conducted with the plate 110 even at the time of rotation.

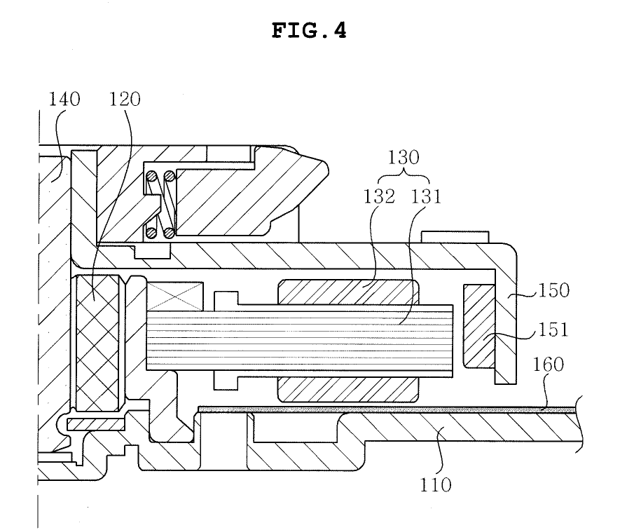

FIG. 4 is a cross-sectional view of a spindle motor according to the third preferred embodiment of the present invention. The top portion of the plate 110 formed to have a step to the upper portion is mounted with the flexible circuit board 160. The flexible circuit board 160 correspondingly contacts the shape of the top portion of the plate 110 and is disposed between the plate 110 and the coil 132, thereby making it possible to prevent beforehand the plate 110 from being conducted with the coil 132 due to the contact therebetween even at high-speed rotation of the motor.

The spindle motor 100 includes a bearing holder (not shown) and the plate 110 is provided with the fixing part of the bearing holder (not shown) and the flexible circuit board 160 is provided with a bending part corresponding to the fixing part.

That is, the flexible printed board 160 is mounted on the top portion thereof to correspond to the shape of the plate 110 and disposed between the plate 110 and the armature 130 to prevent the coil 132 from being contacted and conducted with the plate 110 even at the time of rotation.

The spindle motor 100 according to the preferred embodiment of the present invention disposes one end of the flexible circuit board 160 between the coil of the armature 130 and the plate, thereby making it possible to prevent beforehand the conduction between the armature and the plate.

By the above method, the preferred embodiment of the present invention can secure high performance of the motor without adding separate components, thereby making it possible to save costs. Further, the preferred embodiment of the present invention can basically solve potential defects in terms of quality.

As set forth above, the spindle motor 100 according to the preferred embodiment of the present invention disposes one end of the flexible circuit board 160 between the coil of the armature and the plate, thereby making it possible to previously prevent conduction between the armature and the plate.

By the above method, the preferred embodiment of the present invention can secure the performance of the motor without adding separate components, thereby making it possible to save costs. Further, the preferred embodiment of the present invention can basically solve potential defects in terms of quality.

Although the preferred embodiments of the present invention have been disclosed for illustrative purposes, they are for specifically explaining the present invention and thus the spindle motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A spindle motor including a rotating part having a rotating shaft and a magnet and a fixing part including a bearing supporting the rotating shaft and an armature corresponding to the magnet, the rotating part rotated by electromagnetic force of the magnet and the armature, wherein the fixing part includes:
a plate supporting the rotating shaft; and
a flexible circuit board mounted on the top portion of the plate and disposed between the plate and the armature to shield conduction therebetween.

2. The spindle motor as set forth in claim 1, wherein the side end of the rotating shaft of the flexible circuit board corresponds to the shape of the top portion of the plate.

3. The spindle motor as set forth in claim 1, wherein the fixing part includes a bearing holder, the plate is provided with the fixing part of the bearing holder, and the flexible circuit board is provided with a bending part corresponding to the fixing part.

4. The spindle motor as set forth in claim 3, wherein the plate is formed to be bent upward of the fixing part of the bearing holder and the flexible circuit board is mounted on the top portion of the plate.
